(19) United States
(12) Patent Application Publication
(10) Pub. No.: US 2020/0380959 A1
(43) Pub. Date: Dec. 3, 2020

(54) REAL TIME SPEECH TRANSLATING COMMUNICATION SYSTEM

(71) Applicant: Hsiao-Han Chen, Tainan City (TW)

(72) Inventor: Hsiao-Han Chen, Tainan City (TW)

(21) Appl. No.: 16/883,272

(22) Filed: May 26, 2020

(30) Foreign Application Priority Data
May 27, 2019 (TW) 108118259

(51) Int. Cl. G10L 15/183; G10L 15/22; G06F 3/16; H04R 1/40; H04R 3/00; G10L 15/25; G06K 9/00

(52) U.S. Cl. CPC G10L 15/183; G10L 15/22; G06F 3/167; G10L 2015/223; H04R 3/005; G10L 15/25; G06K 9/00248; H04R 1/406

(57) ABSTRACT

A real time speech translating communication system includes a wearable device that includes: a headset to be worn by a user; an output unit mounted on the headset; an audio recording unit; and a processor coupled to the output unit and the audio recording unit. The processor is programmed to: control the audio recording unit to perform unidirectional sound collection so as to obtain incoming audio data; perform a speech recognition operation on the incoming audio data to obtain speech data that corresponds with the incoming audio data; perform a translation operation on the speech data to obtain translated data in a predetermined language; and control the output unit to output the translated data.

### CROSS-REFERENCE TO RELATED APPLICATION

This application claims priority of Taiwanese Patent Application No. 108118259, filed on May 27, 2019.

### FIELD

The disclosure relates to a translating system, and more particularly to a real time speech translation communication system.

### BACKGROUND

To date, voice language translator devices have been developed to enable people using different languages to have a conversation. In use, a user (such as a person travelling abroad) holding a voice language translator device may speak to the voice language translator device using a first language (e.g., his/her native language). The voice language translator device is configured to receive the speech (in the form of audio) from the user, to recognize the speech to generate a text of the speech, and to translate the text of the speech to a second language (e.g., a native language of another person in a foreign country). The translated text in the second language may then be displayed on a screen to be viewed by the another person, or outputted in audio form by a speaker of the voice language translator device. In turn, the another person may also speak to the voice language translator device in the second language to allow the user to understand the meaning of the speech of the another person after being translated into the first language.

It is noted that in some environments where background noise is present, people who talk with each other with the aid of the voice language translator device may need to hold the voice language translator device close to their mouths in order to enable the voice language translator device to receive the speech clearly. In some cases, the voice language translator device may need to be handed over among multiple people.

### SUMMARY

Therefore, an object of the disclosure is to provide a real time speech translating communication system for performing real time speech translation in a conversation.

According to one embodiment of the disclosure, the real time speech translating communication system includes a wearable device that includes a headset to be worn by a user, an output unit mounted on the headset, an audio recording unit that includes a microphone array which are mounted on the headset and which includes a plurality of microphones spaced apart from one another, and a processor disposed in the headset and coupled to the output unit and the audio recording unit. The processor is programmed to:

control the microphone array of the audio recording unit to perform unidirectional sound collection, so as to obtain incoming audio data,

perform a speech recognition operation on the incoming audio data to obtain speech data that corresponds with the incoming audio data,

perform a translation operation on the speech data to obtain translated data in a predetermined language, and

control the output unit to output the translated data.

### BRIEF DESCRIPTION OF THE DRAWINGS

Other features and advantages of the disclosure will become apparent in the following detailed description of the embodiments with reference to the accompanying drawings, of which:

FIG. 1 is a perspective schematic view of a real time speech translating communication system according to one embodiment of the disclosure;

FIG. 2 is a schematic diagram illustrating a wearable device of the real time speech translating communication system being worn by a user according to one embodiment of the disclosure, when viewed from two sides; and

FIG. 3 is a block diagram illustrating components of the real time speech translating communication system according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

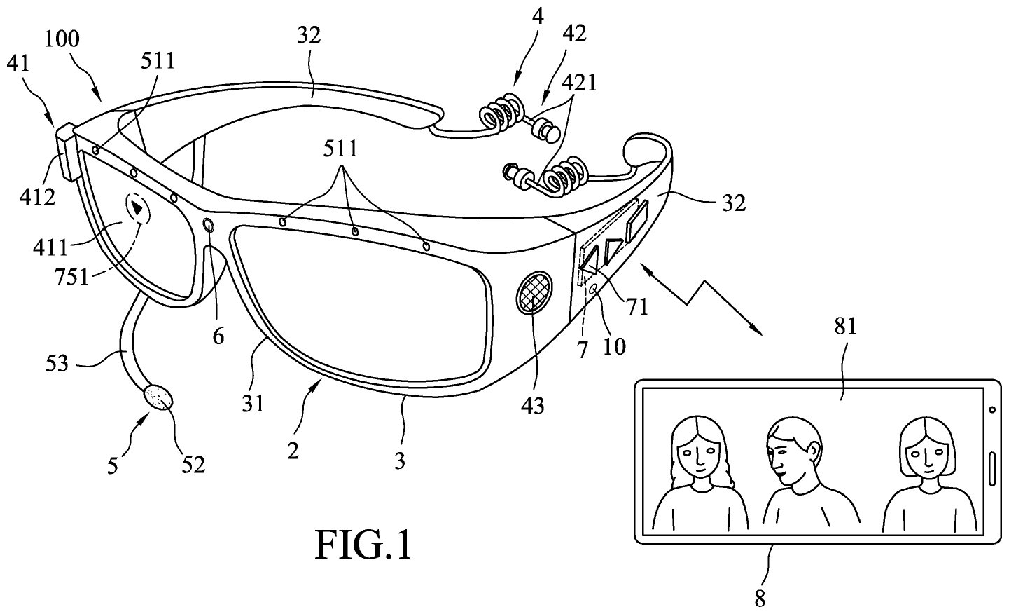

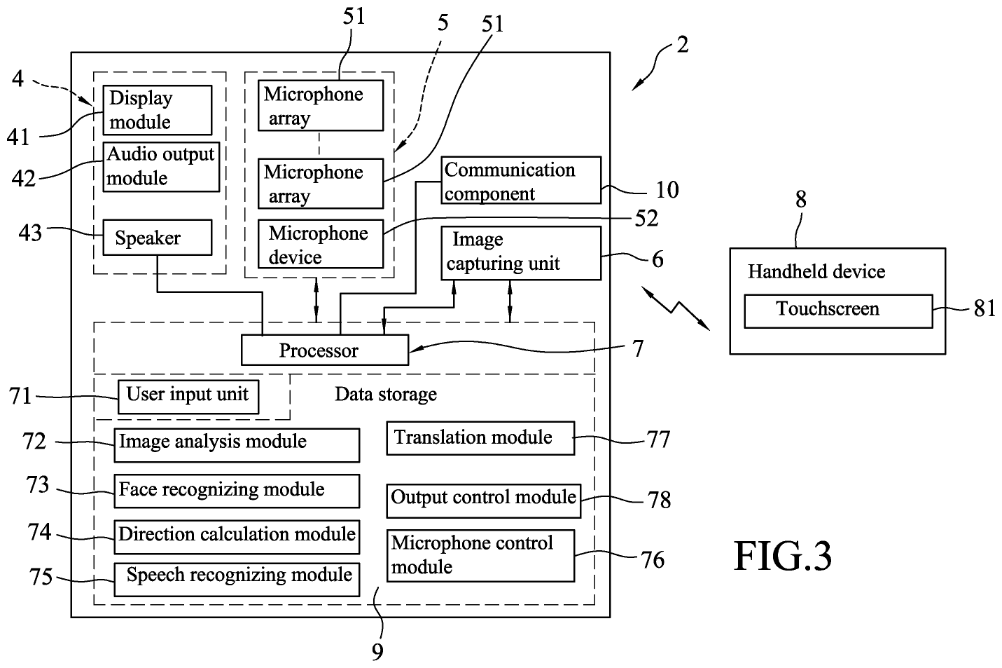

Shown in FIG. 1 is a real time translating communication system 100 according to one embodiment of the disclosure. Components of the system 100 according to one embodiment of the disclosure can be found in FIG. 3.

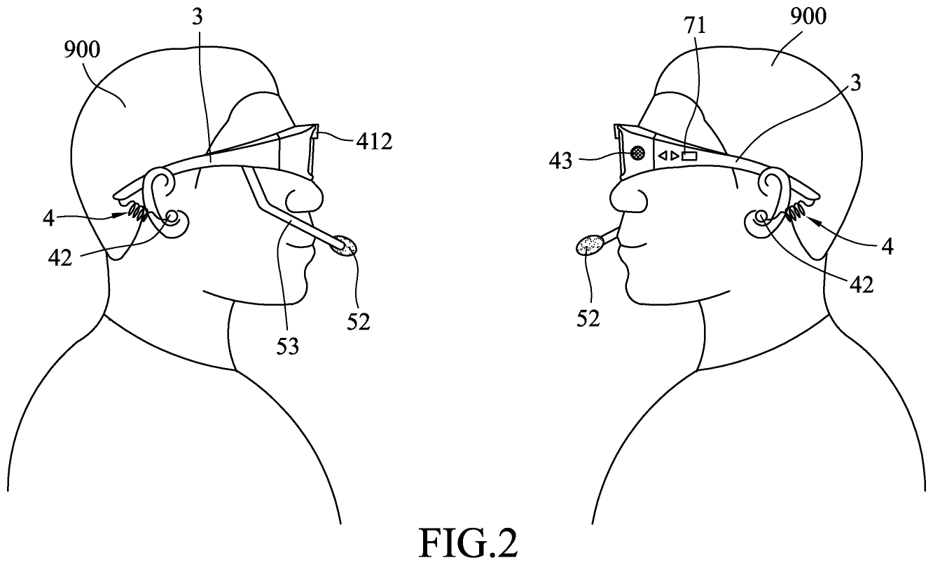

The system 100 is used by a user 900 (see FIG. 2) who is talking with one or more people speaking a language that is different from the user's 900 native language. For example, in a case that the user 900 speaks Mandarin, the system 100 may be used by the user 900 to talk with people who speaks Japanese, Korean, English, German, etc., as a native language.

In this embodiment, the system 100 includes a wearable device 2 and a handheld device 8 communicating with the wearable device 2.

The wearable device 2 includes a headset 3 to be worn by the user 900, an output unit 4 mounted to the headset 3, an audio recording unit 5, an image capturing unit 6, a processor 7, an user input unit 71, a communication component 10, and a data storage 9.

In this embodiment, the headset 3 is in the form of an eyeglasses frame, and includes a rim part 31 and two temple parts 32 that extend respectively from two sides of the rim part 31 (i.e., left and right sides in FIG. 1) and that are spaced apart from each other.

The output unit 4 includes a display module 41, an audio output module 42, and a speaker 43. In this embodiment, the display module 41 is embodied using a transparent lens 411 and an image projecting component 412. The transparent lens 411 is mounted to and supported by the rim part 31 of the headset 3 such that when the headset 3 is worn by the user 900, the transparent lens 411 is placed in front of the eyes of the user 900 (see FIG. 2).

It is noted that in other embodiments, the display module 41 may be embodied using a transparent display screen (such as a liquid crystal display (LCD) display) mounted to the rim part 31 of the headset 3.

The audio output module 42 includes a pair of earphones 421 for outputting audio for the user 900. For example, each of the earphones 421 may be embodied using an air conduction earphone or a bone conduction earphone.

The audio recording unit 5 may include a microphone array 51 that is mounted on the headset 3, and a microphone device 52 that extends from the temple parts 32 of the headset 3.

In use, the microphone array 51 may include a plurality of microphones 511 that are mounted to the rim part 31 and that are spaced apart from each other, and may be controlled to operate in one of an omni-direction mode and a specific-direction mode. In the omni-direction mode, all microphones 511 of the microphone array 51 may be activated so as to collect sound from all directions. In the specific-direction mode, some of the microphones 511 of the microphone array 51 may be selectively activated so as to perform unidirectional sound collection (i.e., collecting sound in a specific direction) using beamforming techniques.

It is noted that by performing the unidirectional sound collection using the microphone array 51, the sound thus collected may have a higher signal-to-noise ratio (SNR), and may be more suitable for the subsequent processing. This configuration may be useful for use in more noisy environments.

The microphone device 52 may be disposed on one tip of a bendable connecting stick 53 that extends from one of the temple parts 32 of the headset 3. In use, the microphone device 52 may be moved, via the bendable connecting stick 53, to be placed in front of the user's 900 mouth.

The image capturing unit 6 may be embodied using a camera that is capable of capturing images. In this embodiment, the image capturing unit 6 is mounted on the rim part 31 of the headset 3 such that when the user 900 wears the headset 3, the image capturing unit 6 is located above the nose of the user 900 and is configured to capture images in front of the user 900.

The processor 7 may be disposed in one of the temple parts 32, and may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

The user input unit 71 includes a number of buttons disposed on the temple parts 32 of the headset 3, so as to enable the user to input a user input command.

The communication component 10 may include a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) and/or fourth generation (4G) of wireless mobile telecommunications technology, and/or the like. Via the communication component 10, the processor 7 of the wearable device 2 can communicate with other components of the system 200 (i.e., the handheld device 8). The communication component 10 may also include a connection port (not shown) for enabling a wired connection with the handheld device 8.

The data storage 9 may be embodied using flash memory or other non-transitory storage medium, and may be integrated with the processor 7. In this embodiment, the data storage 9 stores a number of modules in the form of software instructions. When executed by the processor 7, the modules may cause the processor 7 to perform operations as described below.

Specifically, referring to FIG. 3, the data storage 9 stores an image analysis module 72, a face recognizing module 73, a direction calculation module 74, a speech recognizing module 75, a microphone control module 76, a translation module 77 and an output control module 78.

The handheld device 8 may be embodied using a smartphone, a tablet, a laptop, etc., and includes a touchscreen 81 that serves as a display screen and an input interface, and a communication unit (not depicted in the drawings) that is for establishing a wired or wireless communication with the processor 7 of the headset 3.

In use, when the user 900 intends to understand speech from a person speaking in a specific language, he/she may wear the headset 3 and activate a real time translation function using the user input unit 71 or the touchscreen 81.

In response, the processor 7 is programmed to execute the microphone control module 76 so as to control the microphone array 51 of the audio recording unit 5 to perform unidirectional sound collection, so as to obtain incoming audio data.

Specifically, the processor 7 is programmed to first execute the direction calculation module 74 to determine a collecting direction in which the unidirectional sound collection is to be performed. This may be done by determining a location of a speaking person of interest, and to set a direction toward the location of the speaking person of interest as the collecting direction.

In doing so, the processor 7 controls the image capturing unit 6 to continuously capture images in front of the user, and executes the image analysis module 72 to perform an image processing procedure on the images to detect human faces and to determine whether a human face with lips that are moving is detected. It is noted that the operations of face detection is readily known in the relevant art, and details thereof are omitted herein for the sake of brevity.

When it is determined that a human face with lips that are moving is detected, the processor 7 then executes the direction calculation module 74 to calculate a direction toward the human face based on a location of the human face in the images, and controls the audio recording unit 5 to perform the unidirectional sound collection with respect to the direction toward the human face, so as to obtain the incoming audio data. Specifically, some of the microphones 51 may be selectively activated so as to perform unidirectional sound collection (i.e., collecting audio in the specific direction) using beamforming techniques, based on a position of the human face with lips that are moving in the images.

In the case that a plurality of human faces with lips that are moving are detected, the processor 7 may select one of the human faces as a target speaker, and perform the unidirectional sound collection with respect to a direction toward the target speaker, so as to obtain the incoming audio data. Additionally, the processor 7 may control the display module 41 to display an indicator 751 (such as an arrow) that indicates the direction of the target speaker from the perspective of the user 900.

Meanwhile, the user 900 may operate the user input unit 71 to make another one of the human faces serve as the target speaker. In response to receipt of a user command associated with a selected one of the human faces from the user input unit 71, the processor 7 is configured to set the selected one of the human faces as the target speaker, and perform the unidirectional sound collection with respect to a direction toward the target speaker, so as to obtain the incoming audio data.

In another embodiment, the images captured by the image capturing unit 6 may be displayed on the touchscreen 81, and the user may select one of a number of human faces appearing in the images (by, for example, clicking on one of the human faces appearing on the touchscreen 81), and in response, the processor 7 controls the audio recording unit 5 to perform the unidirectional sound collection with respect to a direction toward the selected one of the human faces, so as to obtain the incoming audio data. Specifically, the click on the touchscreen 81 may result in an input command that is associated with the one of the human faces, and in turn, the handheld device 8 is configured to transmit the input command to the processor 7, thereby enabling the processor 7 to calculate an associated direction for the one of the human faces from the perspective of the user 900, and to control the audio recording unit 5 to perform the unidirectional sound collection with respect to the associated direction.

In some embodiments, when the target speaker is determined, the processor 7 may execute the image analysis module 72 that may include an image cropping function so as to generate an edited image that focuses on the face of the target speaker, and the processor 7 may control the display module 41 to display multiple edited images respectively generated from the images captured by the image capturing unit 6. In this embodiment, the edited image includes the indicator 751 that indicates the direction of the target speaker from the perspective of the user 900. In other embodiments, the edited image may be generated by cropping the (original) image to focus on the face of the target speaker, and transmitted to the handheld device 8 to be displayed.

In one embodiment, the microphone array 51 is configured to perform the unidirectional sound collection with respect to a preset direction (e.g., a front direction that is parallel to a point of view (POV) of the image capturing unit 6). As such, the user 900 may move his/her head to obtain the incoming audio data coming directly in front of him/her.

After obtaining the incoming audio data, the processor 7 is programmed to perform a speech recognition operation on the incoming audio data, so as to obtain speech data that corresponds with the incoming audio data.

Specifically, the processor 7 may execute the speech recognizing module 75 for performing speech recognition operation on the incoming audio data, so as to obtain the speech data in the form of a string of texts. In some embodiments, the speech recognizing module 75 may be embodied using commercially available application programming interfaces (API) such as a speech-to-text API provided by Microsoft Azure®, Google Cloud®, etc., and details thereof are omitted herein for the sake of brevity.

Then, the processor 7 performs a translation operation on the speech data to obtain translated data in a predetermined language.

Specifically, the processor 7 executes the translation module 77 to perform the translation operation. The translation module 77 may include a database that stores data regarding words, grammar and syntax associated with a number of pre-stored languages (e.g., Mandarin, English, Japanese, Korean, German, etc.), and is capable of translating texts from one of the pre-stored languages to another one of the pre-stored languages. In some embodiments, the translation module 77 may be embodied using commercially available APIs such as a speech translation API or a translator text API provided by Microsoft Azure®, Google Cloud®, etc. In some embodiments, the translation module 77 may be operated to establish a connection to an online server for executing the translation operation.

In this embodiment, the user 900 may operate the user input unit 71 or the handheld device 8 to set the predetermined language (which may be a native language of the user). Additionally, the user 900 may operate the user input unit 71 or the handheld device 8 to set one of the pre-stored languages as an input language of the incoming audio data (which is spoken by the target speaker, is different from the predetermined language and may be determined by the user). Alternatively, in some embodiments, the translation module 77 may automatically determine the input language.

The translation operation and the determination of the input language may be performed by commercially available software, and details thereof are omitted herein for the sake of brevity.

After the translation operation, the translated data in the predetermined language may be obtained. Afterward, the processor 7 controls the output unit 4 to output the translated data.

In one example, the processor 7 is programmed to generate a text from the translated data, and control the display module 41 to display the text.

In another example, the processor 7 is programmed to control the image projecting component 412 to project an image that includes the text on the lens 411. Alternatively, in the case that the display module 41 includes the transparent display screen, the processor 7 may directly control the transparent display screen to display the image that includes the text.

In one example, the processor 7 is programmed to generate a voice file from the translated data, and control the audio output module 5 to output the voice file in the predetermined language. Specifically, the processor 7 controls the audio output module 42 to play the voice file for the user 900, such that the user 900 is enabled to understand the meaning of the speech from the target speaker.

It is noted that in some embodiments, the translated data may be outputted in the text form and in the audio form simultaneously.

In one embodiment, in addition to translating the speech from the target speaker in real time, the system 100 is also configured to translate the speech from the user 900 himself/herself.

Specifically, the user 900 may talk into the microphone device 52 in the predetermined language, so as to allow the microphone device to obtain outgoing audio data from the user 900. In response, the processor 7 is programmed to perform the speech recognition operation on the outgoing audio data obtained from the user 900 so as to obtain user speech data in the predetermined language, perform the translation operation on the user speech data to obtain translated data in the input language, and control the output unit 4 to output the translated data. It is noted that the translated data may be outputted in the text form via the display module 41 and/or in the audio form via the speaker 43.

In some embodiments, the system 100 may include a plurality of wearable devices 2 and a plurality of handheld devices 8 for use by a plurality of members that are having a conversation.

Specifically, prior to the conversation, each of the members may wear one of the wearable devices 2, and operate the corresponding user input unit 71 or a corresponding one of the handheld devices 8 to set the predetermined language (which may be a native language of the member). Additionally, in response to one of the members speaking, each of the members may operate the corresponding user input unit 71 or the corresponding handheld device 8 to set one of the pre-stored languages as an input language of the incoming audio data. Alternatively, in some embodiments, the input language may be determined by the translation module 77.

During the conversation, for each of the members, the image capturing unit 6 of the corresponding one of wearable devices 2 continuously captures images, and the processor 7 determines one of the members as the target speaker. Each member may also operate the corresponding user input unit 71 or the corresponding handheld device 8 to manually select one of the other members as the target speaker, and to control the corresponding wearable device 2 to perform the unidirectional sound collection with respect to a direction toward the target speaker, so as to obtain the incoming audio data.

It is noted that in the embodiments where a plurality of wearable devices 2 are present, each of the wearable devices 2 may be embodied without the speaker 43 and the microphone device 52.

To sum up, the embodiments of the disclosure provide a system 100 for performing real time speech translation from one language to another. By configuring the wearable device 2 to perform unidirectional sound collection in a direction associated with the target speaker, and to perform the speech recognition operation on the incoming audio data, the system 100 is capable of obtaining more accurate audio data from the target speaker, which may enhance the quality of the translated data even in noisy environments. Additionally, the operations of the system 100 can be performed while the wearable device 2 is worn by the user 900 without having to switch hands, and can therefore be used more conveniently.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A real time speech translating communication system, comprising a wearable device that includes:
a headset to be worn by a user;
an output unit mounted on said headset;
an audio recording unit that includes a microphone array which are mounted on said headset and which includes a plurality of microphones spaced apart from one another; and
a processor disposed in said headset and coupled to said output unit and said audio recording unit, wherein said processor is programmed to
control said microphone array of said audio recording unit to perform unidirectional sound collection, so as to obtain incoming audio data,
perform a speech recognition operation on the incoming audio data to obtain speech data that corresponds with the incoming audio data,
perform a translation operation on the speech data to obtain translated data in a predetermined language, and
control said output unit to output the translated data.

2. The real time speech translating communication system of claim 1, wherein:
said output unit includes a display module mounted on said headset; and
said processor is programmed to generate a text from the translated data, and control said display module to display the text.

3. The real time speech translating communication system of claim 2, wherein said display module includes:
a transparent lens mounted on said headset such that when said headset is worn by the user, said transparent lens is placed in front of the eyes of the user; and
an image projecting component that is controlled by said processor to project an image that includes the text on said lens.

4. The real time speech translating communication system of claim 2, wherein said display module includes a transparent display screen that is controlled to display the text.

5. The real time speech translating communication system of claim 2, wherein:
said headset includes a user input unit for enabling the user to select one of a plurality of pre-stored languages as an input language of the incoming audio data and another one of the plurality of pre-stored languages as the predetermined language; and
said processor is programmed to perform the speech recognition on the incoming audio data to obtain the speech data in the input language, and perform a translation operation on the speech data to obtain the translated data in the predetermined language.

6. The real time speech translating communication system of claim 1, wherein:
said output unit includes an audio output module mounted on said headset; and
said processor is programmed to generate a voice file from the translated data, and control said audio output module to output the voice file.

7. The real time speech translating communication system of claim 6, wherein:
said headset includes a user input unit for enabling the user to select one of a plurality of pre-stored languages as an input language of the incoming audio data and another one of the plurality of pre-stored languages as the predetermined language; and
said processor is programmed to perform the speech recognition on the incoming audio data to obtain the speech data in the input language, and perform a translation operation on the speech data to obtain the translated data in the predetermined language.

8. The real time speech translating communication system of claim 7, wherein said audio recording unit further includes a microphone device that is mounted on said headset and that includes a plurality of microphones spaced apart from one another, said output unit includes a speaker, and said processor is further programmed to:
control said microphone device of said audio recording unit to perform unidirectional sound collection, so as to obtain outgoing audio data from the user;
perform the speech recognition on the outgoing audio data obtained from the user so as to obtain user speech data in the predetermined language;
perform a translation operation on the user speech data to obtain translated data in the input language; and
control said speaker to output the translated data.

9. The real time speech translating communication system of claim 2, further comprising an image capturing unit that is coupled to said processor, wherein said processor is further programmed to:
control said image capturing unit to continuously capture images in front of the user;
perform an image processing procedure on the images to detect human faces, and to determine whether a human face with lips that are moving is detected;
when it is determined that a human face with lips that are moving is detected, control said audio recording unit to perform the unidirectional sound collection with respect to a direction toward the human face, so as to obtain the incoming audio data.

10. The real time speech translating communication system of claim 9, wherein said processor is further programmed to:
from each of the images captured by said image capturing unit, generate an edited image that focuses on the human face with lips that are moving; and
control said display module to display the edited images generated respectively from the images captured by said image capturing unit.

11. The real time speech translating communication system of claim 10, further comprising a user input unit, wherein said processor is further programmed to:
when it is determined that a plurality of human faces with lips that are moving are detected, select one of the human faces as a target speaker, and perform the unidirectional sound collection with respect to a direction toward the target speaker, so as to obtain the incoming audio data;
in response to receipt of a user command associated with a selected one of the human faces from said user input unit, make the selected one of the human faces serve as the target speaker, and perform the unidirectional sound collection with respect to a direction toward the target speaker, so as to obtain the incoming audio data.

12. The real time speech translating communication system of claim 10, further comprising a handheld device communicating with said wearable device, wherein said handheld device includes a touchscreen that is configured to display the images captured by said image capturing unit and enable the user to input a user command associated with a selected one of the human faces;
wherein, in response to receipt of the user command, said processor is programmed to make the selected one of the human faces serve as the target speaker, and perform the unidirectional sound collection with respect to a direction toward the target speaker, so as to obtain the incoming audio data.

13. The real time speech translating communication system of claim 9, further comprising a user input unit, wherein said processor is further programmed to:
when it is determined that a plurality of human faces with lips that are moving are detected, select one of the human faces as a target speaker, and perform the unidirectional sound collection with respect to a direction toward the target speaker, so as to obtain the incoming audio data;
in response to receipt of a user command associated with a selected one of the human faces from said user input unit, make the selected one of the human faces serve as the target speaker, and perform the unidirectional sound collection with respect to a direction toward the target speaker, so as to obtain the incoming audio data.

14. The real time speech translating communication system of claim 9, further comprising a handheld device communicating with said wearable device, wherein said handheld device includes a touchscreen that is configured to display the images captured by said image capturing unit and enable the user to input a user command associated with a selected one of the human faces;
wherein, in response to receipt of the user command, said processor is programmed to make the selected one of the human faces serve as the target speaker, and perform the unidirectional sound collection with respect to a direction toward the target speaker, so as to obtain the incoming audio data.
